(19) United States
(12) Patent Application Publication
(10) Pub. No.: US 2012/0090479 A1
(43) Pub. Date: Apr. 19, 2012

(54) Fluid Flavoring Apparatus

(76) Inventor: John Barilovits, Gray Court, SC (US)

(21) Appl. No.: 12/904,111

(22) Filed: Oct. 13, 2010

(51) Int. Cl. A47J 43/07

(52) U.S. Cl. 99/516

(57) ABSTRACT

The present invention provides advantages and alternatives over the prior art by providing a fluid flavoring apparatus that incorporates a flavoring such as a substantially pure sweetener compound that is substantially free of binders and fillers applied upon or within a portion of the flavoring apparatus. The flavoring apparatus may be made in various geometric shapes and of various materials that can facilitate the adhesion of the flavoring material to the fluid flavoring apparatus. The geometric shapes can also facilitate the dissolving of the flavoring in the fluid.

### FIELD OF THE INVENTION

The present invention generally relates to the field of sweeteners. More particularly, the present invention relates to a device for delivering a flavoring such as a highly concentrated sweetener to a fluid or beverage.

### BACKGROUND OF THE INVENTION

Natural non-sugar sweeteners and “artificial sweeteners,” with the term being understood to mean compounds such as such as sodium saccharin, calcium saccharin, aspartame, stevia extracts, etc, provide in their pure form a very concentrated sweetening effect. In their typical crystalline, powder, or granulated form, the volume required of these sweeteners in their pure and un-diluted state that would result in a sweetening effect equivalent to a teaspoon volume of the familiar sucrose sugar is so small that they must be combined with other “fillers” to increase the volume of the sweetener to be practical in certain uses.

The filler is added to substantially increase the volume of the sweetener product for packaging and use. The typical point-of-use package for these sweeteners is individual paper packets of distinctive colors, e.g., pink for Sweet'N Low®, yellow for Splenda®, and light blue for Equal®, among others.

When the artificial sweetener was first marketed decades ago, it was common practice by the manufacturers to include fillers in the sweetener to increase the volume in an effort to make a teaspoon volume of the sweetener product provide approximately the same sweetening effect as a teaspoon of granulated sucrose sugar. This practice, to varying degrees, persists to the present day.

In addition to the fillers, a myriad of various other additives are incorporated into non-sugar sweetener products. Certain of these additional additives provide free-flowing and anti-caking properties to the product. Therefore, it is not only the sweetener that must dissolve into solution when the sweetener is used, but also the fillers, binders, and additives.

Other flavorings and extracts are also available in concentrated forms. A flavor to be added to food is often a complex mixture of individual flavoring substances that has been combined or compounded to provide the desired taste perception, or flavor. In this way, the various human taste receptors are stimulated in a similar way as a known flavor. For example, the flavor humans perceive as “orange” is a complex mixture of over 100 individual substances that each contribute to the flavor as it is perceived by stimulating, among other things, the taste buds of the tongue and the olfactory receptors of the nose.

According to the Flavor and Extract Manufacturers Association of the United States, there are over 2,000 individual single chemically-defined flavoring substances used by flavor manufacturers to formulate flavors. Natural extracts (e.g. vanilla extract) are also used to formulate flavors, and may be directly added to foods in the manufacturing process.

Individual flavoring substances are most often simple organic chemicals composed of carbon, hydrogen, nitrogen, oxygen, and sulfur with a molecular weight of 300 or less, and can either be isolated or extracted from the foods in which they occur naturally, or they may be chemically synthesized.

It is common for flavoring substances to be used in a compounded flavor in similar low quantities at which they are present naturally in food. Accordingly, very little flavoring may be necessary, especially if the flavoring is concentrated, to provide a food or beverage with substantial flavoring.

As will be appreciated by those of skill in the art, the present invention provides for a dispenser of sweetener by incorporating the sweetener upon a fluid flavoring apparatus, and having the sweetener substantially low volume by avoiding fillers, binders, and additives. The present invention can also be used to dispense other flavorings into a liquid or drink. Among other things, the present invention allows for a compact design of a fluid flavoring apparatus.

### SUMMARY OF THE INVENTION

The present invention provides advantages and alternatives over the prior art by providing a fluid flavoring apparatus having a substantially pure sweetener compound that is substantially free of binders and fillers applied upon or within a portion of the fluid flavoring apparatus. The fluid flavoring apparatus may be of a material that is porous or fibrous, providing absorbent properties that allow for the sweeteners to be incorporated into the fluid flavoring apparatus.

Further, the fluid flavoring apparatus may have various geometric forms and profiles, and may incorporate holes, fibers, screens, flutes, grooves, or other geometric features that provide mechanical means to sequester and secure the sweetener to the fluid flavoring apparatus until it is presented into a fluid or beverage at which time, by stirring with the fluid flavoring apparatus partially immersed, it will be dissolved into the fluid or beverage, resulting in the fluid flavoring apparatus becoming substantially void of the applied sweetener, thus sweetening the fluid or beverage.

Also, the fluid flavoring apparatus may have geometric forms that facilitate dissolving and evenly distributing the sweetener throughout a fluid or beverage. For example, the fluid flavoring apparatus may incorporate a broad face, akin to a paddle, so as to increase the turbulence within a liquid when the fluid flavoring apparatus is stirred. Other geometric shapes may also be incorporated. For example, holes in the form of bores or grooves may be incorporated on the fluid flavoring apparatus to further create turbulence in a liquid.

Still further, other geometric shapes can be incorporated so as to provide further functionality to the fluid flavoring apparatus. For example, the fluid flavoring apparatus of the present invention may be made in the form of a paddle or spoon so as to provide scooping or spooning functionality. Also, the fluid flavoring apparatus of the present invention may be made in the form of a straw so as to facilitate the consumption of the fluid or beverage.

According to an embodiment of the invention, the substantially pure sweetener may be applied to or formed into the fluid flavoring apparatus during the manufacturing process of the fluid flavoring apparatus or the pure sweetener may be applied to the fluid flavoring apparatus in a subsequent process upon a pre-manufactured fluid flavoring apparatus.

According to an embodiment of the present invention, the sweetener that is applied to the fluid flavoring apparatus may be any one sweetener compound or a combination of sweetener compounds found to provide a desired sweetening effect.

In yet another embodiment of the invention, flavorings may also be incorporated into the fluid flavoring apparatus. For example, concentrated flavorings, including vanilla, chocolate, cinnamon, etc., may be incorporated or infused into the fluid flavoring apparatus of the present invention.

According to yet another aspect of the present invention, the fluid flavoring apparatus may be packaged individually and subsequently packaged in commingled multiples of individually packaged fluid flavoring apparatuses per package.

According to yet another aspect of the present invention, the fluid flavoring apparatuses are not individually packaged and may be commingled in multiples per package.

According to yet another aspect of the present invention, the fluid flavoring apparatuses may be commingled in a package that provides a means to open the package in such a manner as to expose only the portion of the fluid flavoring apparatus that is substantially free of applied sweetener.

According to yet another aspect of the present invention, the fluid flavoring apparatus, having the sweetener applied, may be presented for use in a purpose-built dispensing mechanism similar to a toothpick dispenser.

According to yet another aspect of the present invention, the fluid flavoring apparatus, each being individually packaged, may be presented for use in a purpose-built dispensing mechanism similar to a toothpick dispenser.

According to yet a further aspect of the present invention, the fluid flavoring apparatus may be of any size, shape, or length, and may have the appropriate amount of pure sweetener or combination of pure sweeteners applied thereto, as is suitable to provide sweetening effect equal to that of a typical “pack” or “teaspoon” of sugar or artificial sweetener.

According to yet a further aspect of the present invention, the fluid flavoring apparatus may be of any size, shape, or length, and may have more or less pure sweetener applied thereto, as is suitable to provide application for use with variations in liquid volumes and sweetening intensities.

### BRIEF DESCRIPTION OF THE DRAWINGS

The following drawings, wherein like elements are designated by like reference characters throughout the various views, will be used to more fully describe embodiments of the present invention.

FIG. 1 is a plan view of an exemplary embodiment of a fluid flavoring apparatus having a sweetener applied thereon;

FIG. 2 is a side edge view of an exemplary embodiment of a fluid flavoring apparatus having a sweetener applied thereon;

FIG. 3 is an end edge view of an exemplary embodiment of a fluid flavoring apparatus having a sweetener applied thereon;

FIG. 4 is a top plan view of an exemplary embodiment of a fluid flavoring apparatus having a sweetener applied thereon;

FIG. 4A is a top plan view section drawing of an exemplary embodiment of a fluid flavoring apparatus having a sweetener applied thereon;

FIG. 5 is a side edge view of an exemplary embodiment of a fluid flavoring apparatus having a sweetener applied;

FIG. 6 is an end view of an exemplary embodiment of a fluid flavoring apparatus having a sweetener applied thereon;

FIG. 7 is a top plan view of a fluid flavoring apparatus dispenser, being re-usable or disposable, for a plurality of fluid flavoring apparatuses according to the present invention;

FIG. 8 is a front view of fluid flavoring apparatus dispenser, being re-usable or disposable, for a plurality of fluid flavoring apparatuses according to the present invention; and

FIG. 9 is a side view of fluid flavoring apparatus dispenser, being re-usable or disposable, for a plurality of fluid flavoring apparatuses according to the present invention;

FIG. 10 includes various alternative embodiments for the fluid flavoring apparatus of the present invention;

FIG. 11 is a top plan view of an exemplary embodiment of a fluid flavoring apparatus having a sweetener applied thereon;

FIG. 11A is a top plan view section drawing of an exemplary embodiment of a fluid flavoring apparatus having a sweetener applied thereon;

FIG. 12 is a side edge view of an exemplary embodiment of a fluid flavoring apparatus having a sweetener applied; and

FIG. 13 is an end view of an exemplary embodiment of a fluid flavoring apparatus having a sweetener applied thereon.

### DETAILED DESCRIPTION OF THE INVENTION

With reference now to the figures, the present invention will be described. While the present invention will be described in connection with certain embodiments, it is to be understood that the invention is in no way limited to such embodiments. Instead, it is contemplated that persons of skill in the art may make modifications to such embodiments within the scope of the invention. Thus, it is the intention of the applicant to cover all such alternatives and modifications as may fall within the true spirit and scope of the invention.

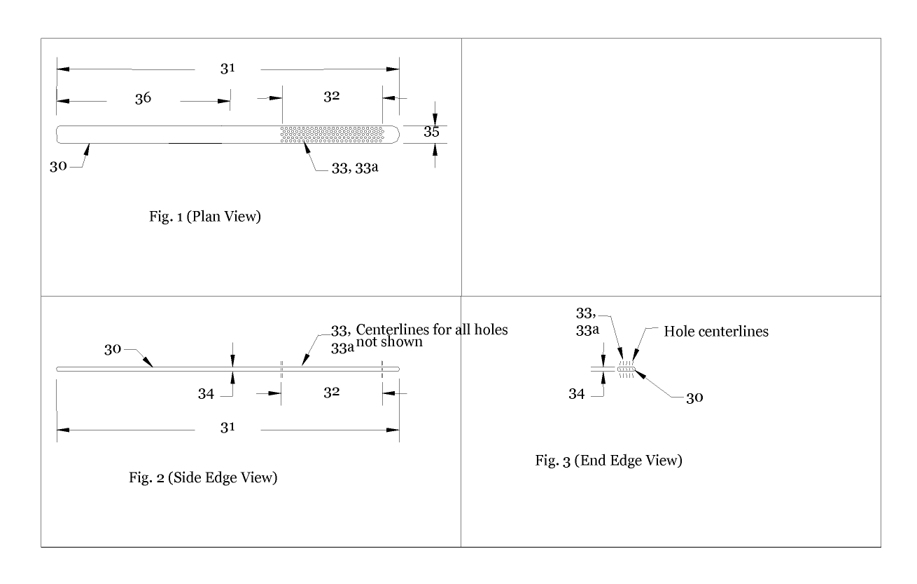

Turning now to FIGS. 1-3, there is shown an exemplary fluid flavoring apparatus 30 according to the present invention. FIG. 1 is a plan view, FIG. 2 is a side edge view, and FIG. 3 is an edge view.

As further shown in FIGS. 1-3, a sweetener compound 33a is applied to fluid flavoring apparatus 30. As further shown, sweetener compound 33a is incorporated into holes 33 in a portion 32 of fluid flavoring apparatus 30. As shown, fluid flavoring apparatus 30 with sweetener 33a applied is preferably constructed such that length 31 is sufficient to provide for a portion 32 having sweetener 33a, being substantially free of fillers and binders, applied to holes 33 in a quantity sufficient to provide a sweetening effect to a typical beverage. Length 31 is preferably a sufficient length so as to provide for the sweetener area 32 to be submerged in a typical beverage cup or glass while in use and still have enough length 36 protruding above the cup or glass to be used to hold onto the fluid flavoring apparatus while stirring the beverage manually. The thickness 34 of fluid flavoring apparatus 30 may be of a dimension such that it will provide enough strength as to render the fluid flavoring apparatus functionally rigid enough to stir a beverage. Likewise, the width 35 (FIG. 1) of the fluid flavoring apparatus may be of a dimension that is suitable to render fluid flavoring apparatus 30 sufficiently rigid enough to stir a beverage.

Sweetener compound 33a may include one or more of the following high-intensity sweeteners: saccharin, aspartame, sucralose, neotame, acesulfame potassium, stevia, and cyclamate. Sweetener compound 33a may also include erythritol, maltitol, sorbitol and xylitol as well as polyols. Many other sweeteners are also appropriate for use in the present invention. Sweetener compound 33a may also be comprised of other flavorings or extracts as may be desired to be dispensed into a beverage.

In the embodiment shown, sweetener 33a is contained within holes 33 so that when fluid flavoring apparatus 30 is placed in a liquid or beverage and stirred, sweetener 33a will dissolve into the liquid or beverage. The dimensions of holes 33 are preferably chosen so as to facilitate the dissolving of sweetener 33a into the liquid or beverage. In an embodiment of the invention, a user of fluid flavoring apparatus 30 can visually confirm that all or most of sweetener 33a is dissolved by looking through the holes. Where most or all of the holes are empty, a user can be assured that the fluid flavoring apparatus 30 has been sufficiently stirred.

In an embodiment of the invention, fluid flavoring apparatus 30 is made of plastic with a length 31 of approximately 6 inches, a width 35 of approximately 0.25 inches, a thickness 34 of approximately 0.06 inches, a diameter of holes 33 of 0.04 inches, a sweetener zone length 32 of approximately 2 inches, and a sweetener-free zone length 36 of approximately 3 inches. In yet another embodiment, fluid flavoring apparatus 30 is made of wood with substantially similar dimensions. Many other dimensions, however, are possible without deviating from the teachings of the present invention.

In an embodiment of the invention, the number of holes 33 can be approximately 100. Dimensions of holes 33 are chosen so as to provide an appropriate quantity of sweetener 33a. For example, the volume, V, for the collection of holes 33 is given by the formula

V=Nπr²t

where N is the number of holes, r is the radius of an individual hole and t is the thickness 34 for the fluid flavoring apparatus. Thus, for a desired sweetening effect, the volume, V, of particular sweetener 33a can be known. With such information, there can then be variability of design where the radius of holes, the thickness 34, and the number of holes, and the type of flavoring, among other things, may be adjusted to provide the desired sweetening or flavoring effect.

Because an embodiment of the invention makes use of a substantially pure sweetener 33a, such sweetener can be concentrated thereby requiring a small volume of sweetener. In turn, the number of holes that are required may be small, the thickness may be kept small, or the radius may be kept small. These various factors can be a matter of design with the result, in any case, being a fluid flavoring apparatus 30 where the sweetener 33a does not substantially increase its size or bulk.

Note that although certain embodiments of the present invention are described in conjunction with a sweetener such as sweetener 33a, the present invention may also incorporate other flavorings instead of or in conjunction with sweeteners without deviating from the teachings of the present invention. For example, instead of using a sweetener, extracts or flavorings may be used.

In other embodiments, sweetener compound 33a may be non-sugar or sugar-based compounds), where the compound form a labyrinth structure. For example, sweetener compound may be a sugar based compound such as what is known as a foam or dry foam sweetener containing sugar, hydroxypropylcellulose, and aqueous silicon dioxide.

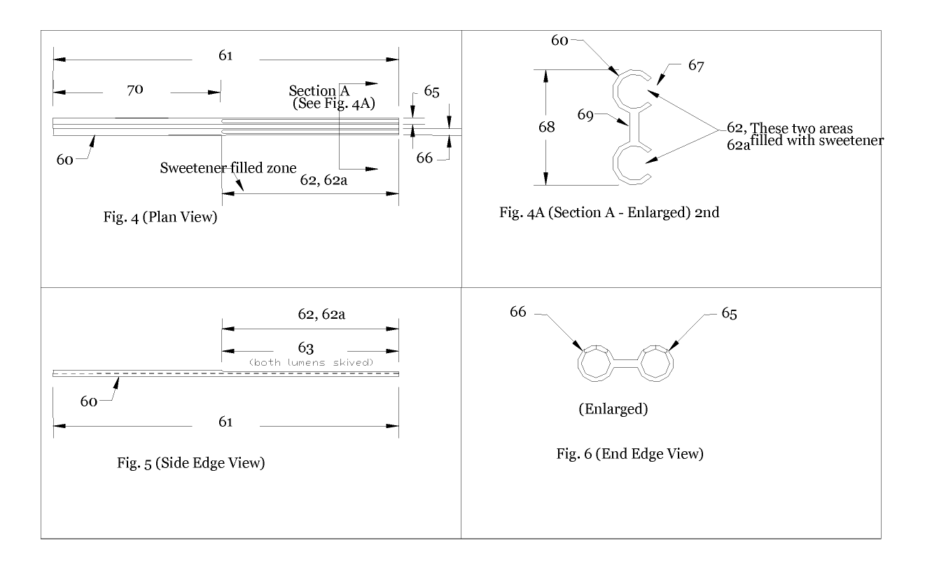

Shown in FIGS. 4-6, is another embodiment of the present invention. FIG. 4 is a plan view, FIG. 5 is a side edge view, and FIG. 6 is an edge view. Also, FIG. 4a depicts an enlarged section drawing view of the embodiment of FIG. 4.

As shown, fluid flavoring apparatus 60 includes two substantially tubular lumens 65 and 66. As further shown the lumens include a length 70 of lumens that are intact and a length 62 of lumens that are skived. As shown, sweetener 62a is preferably applied along the length 62 of the skived lumens.

In an embodiment, the internal diameters of the lumens 65 and 66 (see FIGS. 4a and 6) are approximately 0.05 inches. The length 62 of the skived sections of the lumens (see FIG. 5) is approximately 3 inches. The degree of skiving 67 (see FIG. 4A) is approximately 120 degrees of the diameter which provides sufficient volume into which sweetener 62a, being substantially free of fillers and binders, is to be applied in a quantity sufficient to provide a sweetening effect to a typical beverage.

In an embodiment of the invention, fluid flavoring apparatus 60 is made of plastic. Length 61 of approximately 3 inches is preferably constructed to a sufficient dimension so as to provide for sweetener area 62 and sweetener 62a to be submerged in a typical beverage cup or glass while in use and still have enough length 70 protruding above the cup or glass to be used to hold onto fluid flavoring apparatus 60 while stirring the beverage. The wall thickness of lumens 65 and 66 (FIGS. 4 and 6) is approximately 0.015 inches. The inside diameter of lumens 65 and 66 is approximately 0.030 inches. The width 69 is approximately 0.100 inches and acts as a ribbing for the lumens (FIG. 4A). The dimension 68 is approximately 0.23 inches. The typical material for this embodiment is a plastic that provides enough strength as to render the fluid flavoring apparatus functionally rigid enough to stir a beverage.

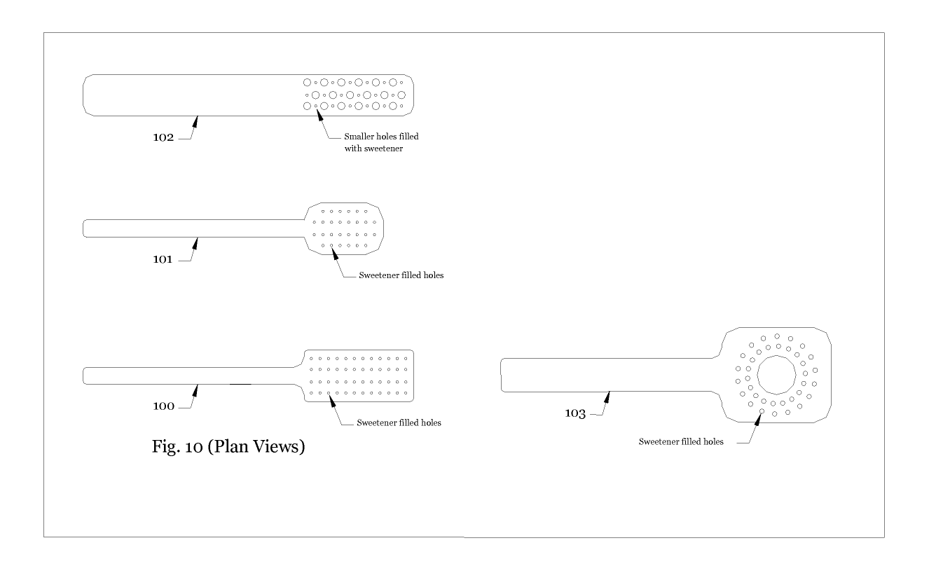

Because the present invention uses a sweetener and other flavorings that are concentrated and low in volume, there can be much variability in design while keeping within the teaching of the present invention. For example, shown in FIG. 10 are other embodiments of the present invention.

As shown in FIG. 10, fluid flavoring apparatus 100 is a modification of fluid flavoring apparatus 30 that incorporates a paddle-type design wherein the handle portion is narrower than the sweetener containing portion. Fluid flavoring apparatus 100 provides a further advantage in that it is able to create more turbulence in the liquid or beverage so as to more efficiently dissolve the sweetener.

Shown in FIG. 10 is also fluid flavoring apparatus 101 that is akin to the shape of a spoon and can be used as such. For example, prior to dissolving the sweetener and exposing the holes, fluid flavoring apparatus 101 can be used to dispense other materials into a liquid or beverage. For example, fluid flavoring apparatus 101 can be used to sprinkle spices such as cinnamon or nutmeg into a liquid or beverage. Indeed, even after the holes are exposed when the sweetener is dissolved away, fluid flavoring apparatus 101 can continue to be used for spooning purposes. Moreover, the paddle-like feature of fluid flavoring apparatus 101 provides for increased stirring turbulence to more efficiently dissolve the sweetener in a liquid or beverage.

Fluid flavoring apparatus 102 as shown in FIG. 10 is a further modification of fluid flavoring apparatus 30 that incorporates some holes that are filled with sweetener (shown as the smaller holes) and other holes that are empty (shown as the larger holes) and designed to increase turbulence in the liquid or beverage when stirred. This design allows for the sweetener to be more efficiently dissolved.

Fluid flavoring apparatus 103 is yet another modification of fluid flavoring apparatus 30 that incorporates a large empty hole with many smaller sweetener filled holes.

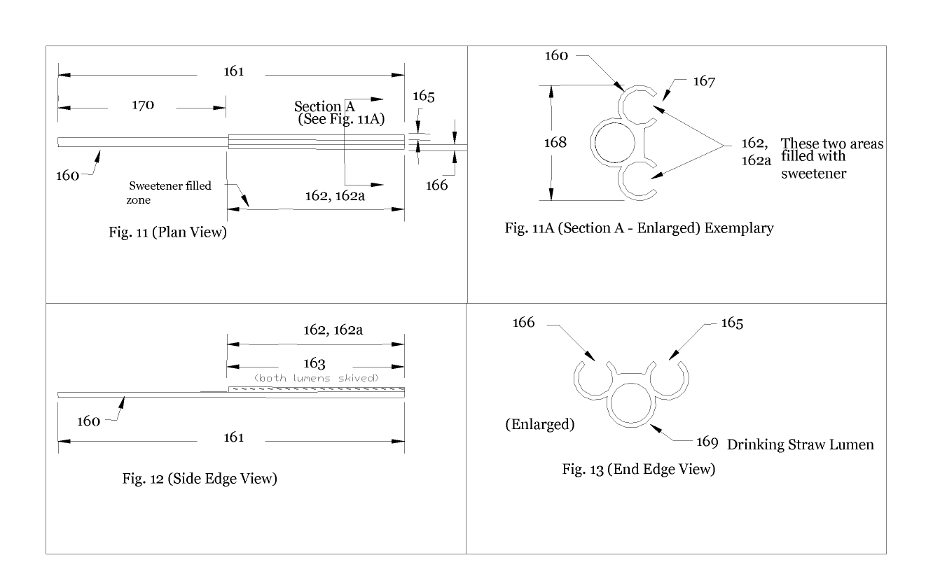

Shown in FIGS. 11, 11A, 12, and 13 is fluid flavoring apparatus 160 that is a modification of fluid flavoring apparatus 60. More particularly, fluid flavoring apparatus 160 is generally in the form of a straw and can be used for drinking purposes. Fluid flavoring apparatus 160 incorporates skived lumens 162 and 163 that contain a sweetener. The combination of the radius of the fluid flavoring apparatus 160 with the skived lumens allows for creating increased turbulence in a liquid or beverage so as to more efficiently dissolve the sweetener.

Shown in FIGS. 11A is Section A from FIG. 11. As shown in FIG. 11A, fluid flavoring apparatus 160 includes two skived portions that are substantially circular and that allow for holding a quantity of sweetener or other flavoring that may be dissolved in a fluid. Shown in FIG. 13 is an end view of fluid flavoring apparatus that further demonstrates a the structure shown in FIG. 11A. As would be obvious to those of ordinary skill in the art many variations to this embodiment are possible. For example, the number of skived portions can be changed, e.g., increased. Also, the radius of the substantially circular skived portions can be changed. Also, the sweetener containing portions need not be substantially circular and can be other geometric shapes.

Many other embodiments are possible while keeping within the teachings of the present invention. For example, other embodiments may incorporate geometrical features such as undulations, fibers, screens, flutes, grooves, holes, skivings, slots, slits, openings, scallops, imprintings, perforations, texturings.

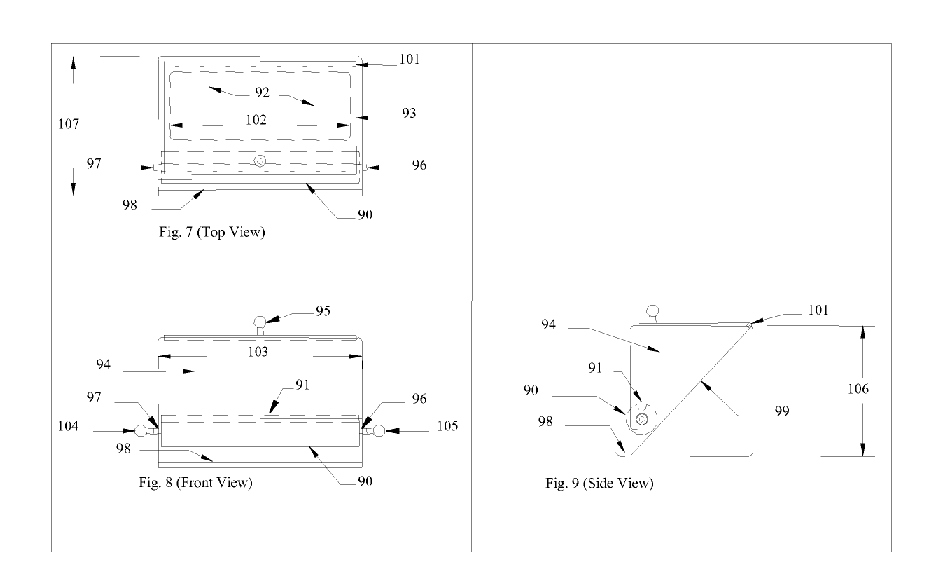

Shown in FIGS. 7-9 is a fluid flavoring apparatus dispenser according to an embodiment of the invention. In FIG. 7 there is illustrated a top plan view of an exemplary fluid flavoring apparatus dispenser such as may be utilized to dispense a single fluid flavoring apparatus from a multitude of fluid flavoring apparatuses from within the enclosure formed by the housing of the dispenser. In FIG. 8, there is illustrated a front view of the exemplary fluid flavoring apparatus dispenser. At FIG. 9 there is illustrated a side view of the exemplary fluid flavoring apparatus dispenser.

As illustrated in FIGS. 7-9, the fluid flavoring apparatus dispenser provides for the enclosure and singular dispensing of a multitude of fluid flavoring apparatuses. The forwardly downward slope of internal surface 99 is provided to cause the fluid flavoring apparatuses placed within enclosure volume 94 to move by gravity toward dispensing drum 90. The fluid flavoring apparatuses are placed within enclosure 94 via opening 92. Cover 93, hinged at 101, equipped with knob 95, provides access to opening 92. Width 102 of opening 92 is provided at the measurement suitable for various lengths of fluid flavoring apparatuses, with total width 103 (FIG. 8) of the dispenser corresponding.

Dispensing drum 90 is formed having groove 91 along its length to provide a cradle into which a fluid flavoring apparatus will fall by gravity when the groove is positioned toward the fluid flavoring apparatuses sequestered in enclosure volume 94. The dispensing drum, having received a fluid flavoring apparatus in the groove, can be rotated manually upon axle journals 96 and 97. The axle journals are supported in bearing bores in the sides of the enclosure at 96 and 97. The manual rotation of the drum is via either of the knobs at 104 or 105. The preferably counterclockwise rotation of the drum, as viewed in FIG. 9 (Side View), provides transport of a fluid flavoring apparatus cradled in the drum groove to the outside of enclosure 94 when the groove in the drum is rotated to a clocking position at the front of the enclosure. When the position of the groove is rotated sufficiently downward, the fluid flavoring apparatus falls by gravity from the groove to the trough below at 98, completing a dispensing cycle.

By rotating the drum around further to cause the drum groove to once again come into contact with the multitude of fluid flavoring apparatuses within the enclosure, the cycle may be repeated.

While the invention has been generally described above in connection with certain preferred embodiments, it is to be understood that the invention is in no way limited to such illustrated and described embodiments. To the contrary, it is contemplated that persons of skill in the art may make modifications to such preferred embodiments within the scope of the invention. Thus, it is the intention of the applicant to cover all such alternatives and modifications as may fall within the true spirit and scope of the invention. For example, the teachings of the present invention, can be extended to different geometric forms or configurations. Moreover, the teachings of the present invention can be extended to various types of flavorings, including highly concentrated flavorings. It should also be appreciated by those skilled in the art that such modifications do not depart from the scope of the invention as set forth in the appended claims.

What is claimed is:

1. An fluid flavoring apparatus comprising:
a substrate having at least a first length, a first width, and a first thickness;
a plurality of openings disposed on the substrate;
a quantity of a concentrated flavoring disposed in a first set of the plurality of openings.

2. The fluid flavoring apparatus of claim 1, comprising a second set of the plurality of openings that are empty.

3. The fluid flavoring apparatus of claim 1, wherein a second set of the plurality of openings is of a different size from the first set of the plurality of openings.

4. The fluid flavoring apparatus of claim 1, wherein the substrate includes a flavoring containing portion that has dimensions of a second length, a second width, and a second thickness, wherein the plurality of openings are disposed.

5. The fluid flavoring apparatus of claim 1, wherein the substrate is substantially in the form of a paddle.

6. The fluid flavoring apparatus of claim 1, wherein the substrate is substantially in the form of a spoon.

7. The fluid flavoring apparatus of claim 1, wherein the openings are in the form of circles.

8. The fluid flavoring apparatus of claim 1, wherein the openings are in the form of parallelograms.

9. The fluid flavoring apparatus of claim 1, wherein the openings are in the form of ovals.

10. The fluid flavoring apparatus of claim 1, wherein the concentrated flavoring is substantially free of fillers.

11. The fluid flavoring apparatus of claim 1, wherein the concentrated flavoring is substantially free of additives.

12. The fluid flavoring apparatus of claim 1, wherein the concentrated flavoring is substantially free of anti-caking additives.

13. The fluid flavoring apparatus of claim 1, wherein the concentrated flavoring is substantially free of free-flowing additives.

14. The fluid flavoring apparatus of claim 1, wherein the concentrated flavoring is substantially free of binders.

15. The fluid flavoring apparatus of claim 1, further comprising a flavoring product disposed in a second set of the plurality of openings.

16. The fluid flavoring apparatus of claim 1, wherein the concentrated flavoring is a concentrated sweetener that includes at least one sweetener selected from the group of saccharin, aspartame, sucralose, neotame, acesulfame potassium, stevia, cyclamate, erythritol, maltitol, sorbitol, xylitol, and polyols.

17. The fluid flavoring apparatus of claim 1, wherein the first length, first width, and first thickness are chosen so as to provide the substrate with sufficient stiffness to stir a fluid.

18. The fluid flavoring apparatus of claim 17, wherein the fluid is substantially comprised of water.

19. The fluid flavoring apparatus of claim 1, wherein the quantity of the concentrated flavoring is selected to substantially correspond to a sweetening effect of one teaspoon of sucrose.

20. The fluid flavoring apparatus of claim 1, wherein the quantity of the concentrated flavoring is selected to substantially correspond to an integer multiple of one teaspoon of sucrose.

21. The fluid flavoring apparatus of claim 1, wherein the substrate incorporates at least one of the following geometrical features: undulations, fibers, screens, flutes, grooves, holes, skivings, slots, slits, openings, scallops, imprintings, perforations, texturings.

22. The fluid flavoring apparatus of claim 1, wherein the substrate incorporates features that produce volumetric, adhesive capacity, or surface area to facilitate the adhesion of the flavoring to the substrate.

23. The fluid flavoring apparatus of claim 1, wherein the plurality of openings are dispersed throughout the first length of the substrate.

24. The fluid flavoring apparatus of claim 1, wherein the plurality of opening are dispersed throughout a second length of the substrate, wherein the second length is less than the first length.

25. The fluid flavoring apparatus of claim 1, wherein the substrate is formed of wood.

26. The fluid flavoring apparatus of claim 1, wherein the substrate is formed of plastic.

27. The fluid flavoring apparatus of claim 1, wherein the substrate is formed of plant material.

28. The fluid flavoring apparatus of claim 1, wherein the substrate is formed of a non-polymer material.

29. The fluid flavoring apparatus of claim 1, wherein the substrate is formed of paper material.

30. The fluid flavoring apparatus of claim 1, wherein the substrate is formed of rigid screen material.

31. The fluid flavoring apparatus of claim 1, wherein the flavoring is a foam or dry foam sweetener.

32. A fluid flavoring apparatus comprising:
a substantially tubular substrate having at least a first length, a first radius, and a first tubular wall thickness;
a quantity of a concentrated flavoring disposed on the substantially tubular substrate.

33. The fluid flavoring apparatus of claim 32, wherein the substantially tubular substrate is skived for second length that is less than the first length.

34. The fluid flavoring apparatus of claim 33, wherein the concentrated flavoring is disposed within the skived portion of the substantially tubular substrate.

35. The fluid flavoring apparatus of claim 32, wherein the substantially tubular substrate includes ridges on which the concentrated flavoring is disposed.

36. The fluid flavoring apparatus of claim 32, wherein the substantially tubular substrate is substantially in the form of a straw.

37. The fluid flavoring apparatus of claim 32, wherein the concentrated flavoring is substantially free of fillers.

38. The fluid flavoring apparatus of claim 32, wherein the concentrated flavoring is substantially free of additives.

39. The fluid flavoring apparatus of claim 32, wherein the concentrated flavoring is substantially free of anti-caking additives.

40. The fluid flavoring apparatus of claim 32, wherein the concentrated flavoring is substantially free of free-flowing additives.

41. The fluid flavoring apparatus of claim 32, wherein the concentrated flavoring is substantially free of binders.

42. The fluid flavoring apparatus of claim 32, further comprising a second substantially tubular substrate having at least a second length, a second radius, and a second tubular wall thickness, wherein the second substantially tubular substrate is attached to the substantially tubular substrate.

43. The fluid flavoring apparatus of claim 42, wherein the first length, the second radius, and the first tubular wall thickness are substantially similar to the second length, the second radius, and the second tubular wall thickness, respectively.

44. The fluid flavoring apparatus of claim 32, wherein the concentrated flavoring is a concentrated sweetener that includes at least one sweetener selected from the group of saccharin, aspartame, sucralose, neotame, acesulfame potassium, stevia, cyclamate, erythritol, maltitol, sorbitol, xylitol, and polyols.

45. The fluid flavoring apparatus of claim 32, wherein the first length, the second radius, and the first tubular wall thickness are chosen so as to provide the substrate with sufficient stiffness to stir a fluid.

46. The fluid flavoring apparatus of claim 45, wherein the fluid is substantially comprised of water.

47. The fluid flavoring apparatus of claim 32, wherein the quantity of the concentrated flavoring is selected to substantially correspond to a sweetening effect of one teaspoon of sucrose.

48. The fluid flavoring apparatus of claim 32, wherein the quantity of the concentrated flavoring is selected to substantially correspond to an integer multiple of one teaspoon of sucrose.

49. The fluid flavoring apparatus of claim 32, wherein the substrate incorporates at least one of the following geometrical features: undulations, fibers, screens, flutes, grooves, holes, skivings, slots, slits, openings, scallops, imprintings, perforations, texturings.

50. The fluid flavoring apparatus of claim 32, wherein the substrate incorporates features that produce volumetric, adhesive capacity, or surface area to facilitate the adhesion of the flavoring to the substrate.

51. The fluid flavoring apparatus of claim 32, wherein the substrate is formed of wood or other plant material.

52. The fluid flavoring apparatus of claim 32, wherein the substrate is formed of plastic.

53. The fluid flavoring apparatus of claim 32, wherein the substrate is formed of a non-polymer material.

54. The fluid flavoring apparatus of claim 32, wherein the substrate is formed of paper material.

55. The fluid flavoring apparatus of claim 32, wherein the substrate is formed of rigid screen material.

56. The fluid flavoring apparatus of claim 32, wherein the flavoring is a foam or dry foam sweetener.
